(19) United States
(12) Patent Application Publication
(10) Pub. No.: US 2019/0168624 A1
(43) Pub. Date: Jun. 6, 2019

(54) ENERGY STORAGE DEVICE FOR A MOTOR VEHICLE, AND MOTOR VEHICLE

(71) Applicant: AUDI AG, Ingolstadt (DE)

(72) Inventors: Reinhard PEER, Gaimersheim (DE); Florian GROSSHAUSER, Poernbach (Puch) (DE); Matthias HARDT, Neubiberg (DE)

(73) Assignee: AUDI AG, Ingolstadt (DE)

(21) Appl. No.: 16/323,559

(22) PCT Filed: Jul. 6, 2017
(86) PCT No.: PCT/EP2017/067046

§ 371 Date: Feb. 6, 2019

(30) Foreign Application Priority Data
Aug. 16, 2016 (DE) 10 2016 215 285.8

(51) Int. Cl. B60L 53/12; H01F 38/14; H02J 5/00; H02J 50/10

(52) U.S. Cl. CPC B60L 53/12; H02J 50/10; H02J 5/005; H01F 38/14

(57) ABSTRACT

An energy storage device for a motor vehicle. A housing and at least one energy storage device mounted in the housing. A coil device is provided, which is designed for inductively supplying energy via an external magnetic field in order to charge the energy storage, and which is arranged on an outer surface of the housing.

The invention relates to an energy storage device for a motor vehicle, comprising a housing and at least one energy storage mounted in the frame

Such energy storage devices are used in fully or partially electrically powered motor vehicles in order to provide electrical energy for a drive unit of the motor vehicle. The energy storage device is often installed in the area of the underbody of the motor vehicle due to their large volume. The use of inductive energy transfer for charging the energy storage device is something that has already been proposed, i.e., a magnetic field is generated by a power source arranged within the infrastructure, e.g., a roadway, inducing a voltage in the motor vehicle in order to charge the energy storage device. Typically, separate secondary coils are arranged in the front-axle or front-subframe area of the vehicle, after large parts of the underbody are being utilized by the energy storage device itself.

However, the area of the front axle or the front subframe allows for only a very small installation space, which entails a correspondingly small size of the secondary coil. However, since the performance of the inductive energy transmission depends substantially on the coil area available for coupling with the energy source, only relatively low power can be provided for charging the energy storage device . Moreover, solid ferrite plates or tiles of the secondary coils used to guide the magnetic flux are very fragile and must be mechanically protected in solid enclosures.

The invention is therefore based on the object of providing an improved and more robust way of inductively charging an energy storage device in a motor vehicle over the prior art.

This object is achieved according to the invention in an energy storage device of the type mentioned in the introduction by providing a coil device, which is designed for inductive energy supply via an external magnetic field in order to charge the energy storage, and which is arranged on an outer surface of the housing.

The invention is based on the notion of utilizing the area of the outer surface of the housing of the energy storage device in order to attach the secondary coil device by placing the coil device itself on the energy storage device. The energy storage device can then be installed in the motor vehicle, such that the coil device is facing the vehicle base and the external magnetic field, which is provided, e.g., by a primary energy source installed in the vehicle base, can be coupled for energy supply. In the vehicle itself, no additional installation space for a separate coil device is needed. Instead, the entire extension of the outer surface of the housing may be used for the supply of energy. The area of the coil device effectively secondarily available for inductive energy supply is therefore substantially larger than is the case with a conventional arrangement in the area of the front axle or the front subframe. This significantly increases the performance of a charging process.

The energy storage device may be equipped with a charging device designed to convert a voltage induced by the magnetic field into a voltage level provided for charging the energy storage. Alternatively, the energy storage device may have an interface for connecting a motor-vehicle charging device, which is external to the energy storage device, and/or have an interface for charging the energy storage devices via the charging device, which is external to the energy storage device. Additional advantages of the energy storage device according to the invention also come about, if the housing is magnetically conductive on at least the coil device side in order to shield the magnetic field against the energy storages. The energy storage device may also have a cooling device for cooling the energy storages, which in addition may dissipate the heat of the coil device generated during the inductive supply of energy.

For the energy storage device according to the invention. it is further preferred that the coil device has at least one circular conductor track, wherein a voltage can be induced by the magnetic field. Such a conductor track typically extends in one plane and/or describes a spiral, in particular a polygonal spiral. For this reason, the conductor track may also be referred to as a flat coil. The coil device may therefore advantageously be designed as especially thin. The conductor track may have a thickness between 0.5 and 3 mm, preferably between 0.8 and 1.2 mm, and/or have a width between 10 and 40 mm, preferably 16 and 24 mm. The conductor cross-section of the conductor track is preferably between 10 and 40 mm², more preferably between 16 and 24 mm². Two parallel conductor-track sections are advantageously spaced apart by between 25 and 100%, in particular between 40 and 60%, of the width of the conductor track. The outer dimensions of the conductor track(s) are preferably between 500×500 mm² and 1200×1200 mm², more preferably between 700×700 mm² and 900×900 mm².

In order to realize suitable conductor-track geometries with a sufficient cross-section and low skin effect, the conductor track can be formed from a copper sheet. The conductor track may, e.g., be punched out of the copper sheet. Alternatively or additionally, the conductor track may be formed from a copper-mesh material. Such a copper-mesh material is known, e.g., in the form of a copper mesh-tape for ground cables.

In addition, a second conductor track may be provided, which is guided in an opposite direction to the first conductor track. Such a track arrangement is also referred to as a double-D coil and enables a particularly effective coupling of the magnetic field.

Furthermore, with regard to the energy storage device according to the invention, the coil device preferably has a magnetically conductive support, with which it may be fastened to the housing. The support is used for guiding the magnetic flux generated by the magnetic field, in particular in the direction of the conductor track(s). The support is advantageously arranged directly on the outer surface of the housing, and in particular motion-coupled thereto. The conductor track(s) may be arranged on the support surface opposite the housing. In a cross-sectional view, this results in a layered structure, comprising the housing, followed by the support and the conductor track(s) arranged thereon. A material with a relative permeability of at least 2, preferably at least 5, is to be considered as magnetically conductive. Typically, the support has a thickness between 5 and 15 mm, preferably between 7 and 12 mm. This results in a coil device of a particularly flat design.

Furthermore, the support may be formed from an elastically deformable substrate material with ferrite admixtures. Rather than a conventional solid ferrite body, it is thus proposed to provide a support, which is elastically deformable, such that forces introduced into the support, when the motor vehicle is being operated, in particular torsional forces, are absorbed thereby without causing breakage. Since the energy storage device according to the invention may be installed in the underbody, typically between body structures extending in the vehicle longitudinal direction, considerable force is applied to the energy storage device housing, which forces can be transmitted to the support arranged thereon. These forces may in particular be in the form of shocks and torsional forces on the housing or the support and motion-coupled thereto. However, by providing the elastically deformable support, these forces may be absorbed thereby without breakage, such that there is no need for mounting the coil device in a special mechanically protected way, e.g., in solid, large-volume housings. In addition, it can be provided that the admixtures be distributed non-homogeneously in the substrate material in order to conduct or absorb the magnetic flux to varying degrees at different points of the support.

The substrate material advantageously is or comprises an elastomer. Hard rubber has proven to be particularly advantageous as a substrate material.

It should be mentioned in this context that the use of an elastically deformable support is not necessarily limited to an energy storage device according to the invention, i.e., the appropriate teaching may also be applied regardless of whether such a support be arranged on an energy storage device. The invention may thus also relate to a motor vehicle comprising a coil device designed for inductive energy supply via an external magnetic field with at least one conductor track, wherein a voltage can be induced by the magnetic field, and a magnetically conductive support for at least one conductor track of the coil device, wherein the support is formed from an elastically deformable substrate material with admixtures of a ferrite. In this way, all embodiments of the energy storage device according to the invention are transferable to this motor vehicle, whereby the advantages of the energy storage device according to the invention area also achievable therewith.

The energy storage device according to the invention may also be provided with a protective element, which covers at least the coil device on the surface facing the housing. Such a protective element serves to protect the underride protection of the energy storage device upon installation on the underbody of a motor vehicle. Since already such protective elements often come standard in conventional energy storage devices, the coil device can be arranged in an existing space between the housing and the protective element. In particular with regard to the integration of the energy storage device in the underbody of the motor vehicle, the protective element may cover the entire outside of the housing. The protective element may be secured to the housing, in particular at a distance from the outer surface of the housing. Alternatively or additionally, the protective element may have fastening means, with which it can be fastened to the vehicle body.

The protective element is advantageously made of a diamagnetic, paramagnetic or magnetically neutral material, or comprises such a material. In other words, the material has poor magnetic conductivity, i.e., it has a relative permeability, e.g., of less than 1.1. Thus, the protective element exerts only a minor influence on the induction processes during energy transmission. Preferably, the material is a fiber-reinforced plastic, in particular a glass-fiber-reinforced plastic (GRP), or comprises such a plastic.

Furthermore, the invention relates to a motor vehicle. The inventive motor vehicle is characterized in that it provides an inventive energy storage device.

All embodiments of the inventive energy storage device are transferable to this inventive motor vehicle, such that the said advantages may also be achieved therewith.

The energy storage device may be arranged in the underbody of the motor vehicle and/or extend at least in sections between two wheel axles of the motor vehicle. In other words, the energy storage device may be placed mid-vehicle. In particular, the energy storage device may be arranged between body structures extending in the longitudinal direction of the vehicle. The energy storage device itself may then contribute to body statics.

Further advantages and details of the invention will become clear from the embodiments described below, and in reference to the drawings. These are schematic illustrations showing:

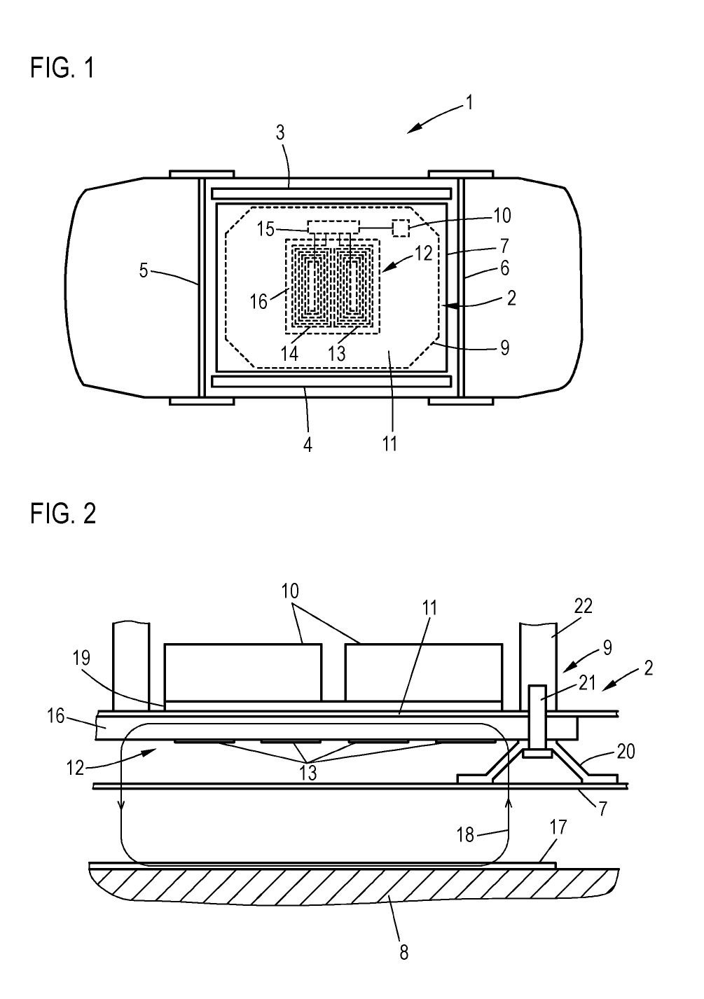

FIG. 1 a schematic diagram of the underbody of an inventive motor vehicle with an inventive energy storage device;

FIG. 2 a cross-section through a portion of the energy storage device shown in FIG. 1;

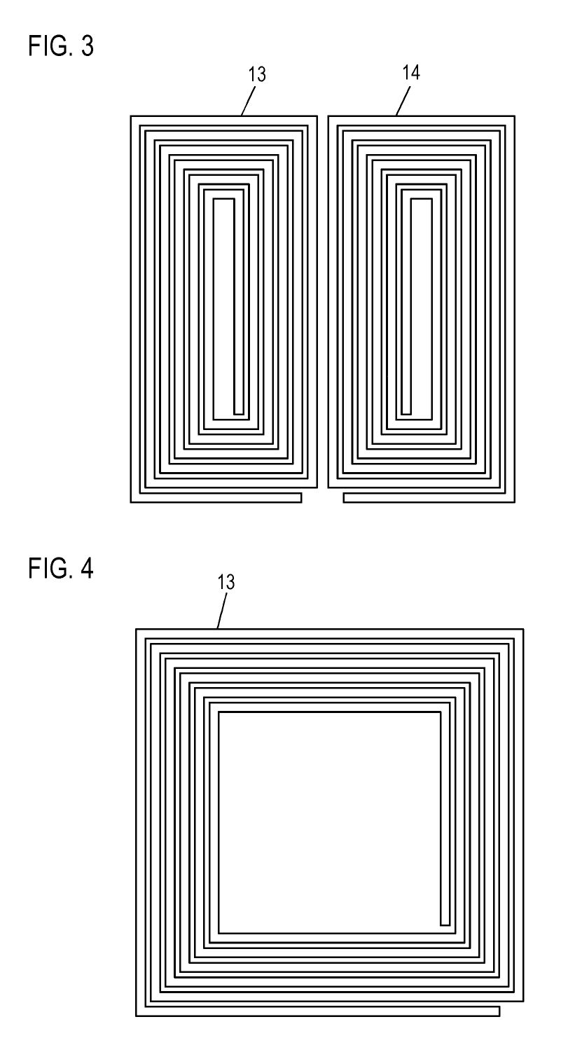

FIG. 3 a plan view of conductor tracks of the energy storage device shown in FIG. 1; and

FIG. 4 a plan view of a conductor track of an inventive energy storage device of another inventive motor vehicle.

FIG. 1 shows a schematic diagram of the underbody of a motor vehicle 1 with an energy storage device 2, which is positioned between two body structures 3, 4 extending in vehicle longitudinal direction, and two wheel axles 5, 6, i.e., in the center of the vehicle.

The energy storage device 2 has a protective element 7 designed as an underride protection, which covers the energy storage device 2 toward the vehicle base 8 (see FIG. 2). The side view from the vehicle underbody shows a housing 9 of the energy storage device 2 behind the protective element 7, in which housing a plurality of energy storage devices 10 are mounted, whereof only one is shown schematically in FIG. 1 for the sake of transparency. The energy storage devices 10 are, e.g., energy lithium-ion-based energy storage modules, which are designed to supply power to a (not shown) drive unit of the motor vehicle 1.

On an outer surface 11 of the housing 9 facing the vehicle base 8, a coil device 12 for supplying inductive energy via a magnetic field external to the motor vehicle is arranged in order to charge the energy storage 10. The coil device 12 has a circular first conductor track 13 and a second conductor track 14, which is also circular and guided in the opposite direction, which form a double-D-shaped conductor-track arrangement and are connected to a charging device 15. It converts a voltage induced by the magnetic field into the conductor track 13, 14 into a proper voltage level for charging the energy storage 10. The charging device 15 is arranged in the energy storage device 2, so as alternatively to allow for the charging device 15 to be arranged externally to the energy storage device, with interfaces corresponding to the coil device 12 and the energy storage 10.

The conductor tracks 13, 14 are arranged on a magnetically conductive support 16 of the coil device 12, which in turn is fastened directly to the outer surface 11 of the housing 9. The support 16 is intended to guide the magnetic flux of the inducing magnetic field to the conductor tracks 13, 14 and consists of an elastomer, e.g., hard rubber, with admixtures of a ferrite. The support 16 is designed to be magnetically conductive due to the admixtures of ferrite, i.e., its material has a relative permeability of at least 5. By fastening the support 16 to the outer surface 11, it becomes motion-coupled to the housing 9, such that forces acting on the housing 9 during vehicle operation, in particular shocks and torsional forces, are also transmitted to the support 16. Due to the design of the support 16 made of an elastically deformable elastomer, these forces can be absorbed without causing breakage, in contrast to traditional, rigid ferrite plates.

The protective element 7 is made of a diamagnetic, paramagnetic or magnetically neutral material, i.e., a material with a relative permeability of less than 1.1, e.g., a glass-fiber-reinforced plastic. Thus, the protective element 7 exerts only a minor influence on the external magnetic field and protects the energy storage device 2, as a whole, including the coil arrangement 12 from damage, if the underbody of the motor vehicle 1 comes into contact with objects.

FIG. 2 shows a cross-section through a section of the energy storage device 2 above the vehicle base 8, upon which an energy source 17 generating the magnetic field is arranged. Thus, an inductive energy transmission system with the primary energy source 17 and the secondary coil device 12 for charging the energy storage 10 is formed.

The outer surface 11 of the housing 9, the support 16 and the conductor tracks 13, 14, of which only sections of the first conductor track 13 are shown in FIG. 2, form a layer structure, which enables a magnetic flux, represented by the electric line of flux, to be conducted from the energy source 17 profile 18 through the support 16 to the tracks 13, 14, and to induce a voltage therein. As can be seen, the inside of the housing 9 is shielded by the support 16 from the magnetic field. Heat generated by the induction process may also be dissipated via an additional cooling device 19, which is thermally coupled to the energy storages 10 in order to cool these.

The protective element 7 is shown as arranged at a distance from the conductor tracks 13, 14 by means of a spacer 20 at the surface of housing 9 opposite the energy storage 10 In addition, a fastening means 21 penetrates the spacer 20 and the support 16, and thus secures the protective element 7 and the coil device 12 on a housing part 22. Hence, a plurality of fastening means 21 are provided over the total length of the coil device 12, as are other (not shown) fastening means for additional securing of the protective element 7 on the body structures 3, 4.

In the motor vehicle 1, the housing 9 in the area of the outer surface 11 has a thickness of, e.g., 2 mm, and the support 16 has a thickness of, e.g., 8 mm. In cross-sectional view, the conductor tracks 13, 14, are e.g., 20 mm wide and 1 mm thick, whereby a sufficient conductor cross-section of 20 mm² for efficient energy supply is provided with little skin effect. Parallel conductor track sections of the conductor tracks 13, 14 are spaced, e.g., 10 mm apart from one another.

FIG. 3 is a plan view of the tracks 13, 14 of the coil device 12. Each conductor track 13, 14 forms a flat, circular coil in order to for the double-D shape. Each conductor tracks 13, 14 together have external dimensions of, e.g., 800×800 mm². The conductor tracks 13, 14 are each punched from a copper sheet or alternatively formed from a copper mesh tape.

FIG. 4 shows a conductor track 13 of a further exemplary embodiment of a motor vehicle 1, which is similar to the one described above, but only has a conductor track 13 realizing a single circular coil. The conductor track 13 has external dimensions of, e.g., 800×800 mm².

1-11 (canceled)

12. An energy storage device for a motor vehicle, comprising:
a housing and at least one energy storage mounted in the housing, wherein a coil device is provided, which is designed for inductively supplying energy via an external magnetic field in order to charge the energy storage and is arranged on an outer surface of the housing. cm 13. The energy storage device according to claim 12, wherein the coil device has at least one circular conductor track wherein a voltage can be induced via the magnetic field.

14. The energy storage device according to claim 13, wherein the conductor track is formed from a copper sheet and/or a copper-mesh material.

15. The energy storage device according to claim 13, wherein a second conductor track is provided, which is guided in directions opposite the first conductor path.

16. The energy storage device according to claim 12, wherein the coil device has a magnetically conductive support, by which it is fastened to the housing.

17. The energy storage device according to claim 16, wherein the support is formed from an elastically deformable substrate material with ferrite admixtures.

18. The energy storage device according to claim 17, wherein the substrate material is an elastomer.

19. The energy storage device according to claim 12, wherein a protective element is provided, which covers at least the coil device on a surface opposite the housing.

20. The energy storage device according to claim 19, wherein the protective element is made of a diamagnetic, paramagnetic or magnetically neutral material.

21. A motor vehicle including an energy storage device according to claim 12.

22. The motor vehicle according to claim 21, wherein the energy storage device (2) can be arranged in the underbody of the motor vehicle and/or extend at least in sections between two wheel axles of the motor vehicle.
